(19) United States
(12) Patent Application Publication
(10) Pub. No.: US 2015/0246476 A1
(43) Pub. Date: Sep. 3, 2015

(54) METHOD FOR FABRICATING RECTANGULAR PATTERED STACKS

(71) Applicant: Seagate Technology LLC, Cupertino, CA (US)

(72) Inventors: Philip Steiner, Los Altos, CA (US); Kim Y. Lee, Fremont, CA (US); Koichi Wago, Sunnyvale, CA (US); Bruce Buch, Westborough, MA (US); David S. Kuo, Palo Alto, CA (US)

(73) Assignee: Seagate Technology LLC, Cupertino, CA (US)

(21) Appl. No.: 14/194,733

(22) Filed: Mar. 2, 2014

(51) Int. Cl. B29C 59/02; B29C 59/00

(52) U.S. Cl. CPC B29C 59/02; B29C 59/002; B29L 2031/001

(57) ABSTRACT

The embodiments disclose an analyzer configured to determine positions of circumferential gratings track features and alignment patterns in a first template and a phase device configured to determine positions of radial gratings features and interspersed pattern fields in a second template, wherein the first template is transferred and cross-imprinted with the second template features and patterns to form a third template substrate as a rectangular patterned stack imprint template.

### BRIEF DESCRIPTION OF THE DRAWINGS

FIG. 1 shows a block diagram of an overview of a method for fabricating rectangular BPM of one embodiment.

FIG. 2A shows a block diagram of an overview flow chart of a method for fabricating a first template of one embodiment.

FIG. 2B shows a block diagram of an overview flow chart of a method for fabricating a second template of one embodiment.

FIG. 2C shows a block diagram of an overview flow chart of a method for fabricating a third template of one embodiment.

FIG. 3A shows for illustrative purposes only an example of a first template of one embodiment.

FIG. 3B shows for illustrative purposes only an example of determining first template patterns of one embodiment.

FIG. 4 shows for illustrative purposes only an example of imprinting a third template with first template patterns of one embodiment.

FIG. 5A shows for illustrative purposes only an example of a third template with first template imprinted patterns of one embodiment.

FIG. 5B shows for illustrative purposes only an example of a servo mask of one embodiment.

FIG. 5C shows for illustrative purposes only an example of circumferential grating guiding pattern density of one embodiment.

FIG. 5D shows for illustrative purposes only an example of a third template with a second resist deposition of one embodiment.

FIG. 6A shows for illustrative purposes only an example of first frequency doubling of circumferential guiding patterns of one embodiment.

FIG. 6B shows for illustrative purposes only an example of second frequency doubling of circumferential guiding patterns of one embodiment.

FIG. 6C shows for illustrative purposes only an example of first template patterns etched into a third template perspective view of a first template of one embodiment.

FIG. 7A shows for illustrative purposes only an example of a second template of one embodiment.

FIG. 7B shows for illustrative purposes only an example of determining a second template patterns of one embodiment.

FIG. 8A shows for illustrative purposes only an example of a third template resist imprinted with second template patterns of one embodiment.

FIG. 8B shows for illustrative purposes only an example of first template patterns etched into a third Cr layer of one embodiment.

FIG. 8C shows for illustrative purposes only an example of an iPLL mask of one embodiment.

FIG. 9A shows for illustrative purposes only an example of first frequency doubling of radial guiding patterns of one embodiment.

FIG. 9B shows for illustrative purposes only an example of second frequency doubling of radial guiding patterns of one embodiment.

FIG. 9C shows for illustrative purposes only an example of second template patterns etched in the third template of one embodiment.

FIG. 9D shows for illustrative purposes only an example of a cross-imprinted rectangular patterned imprint template of one embodiment.

FIG. 9E shows for illustrative purposes only an example of a stack imprinted using the cross-imprinted rectangular patterned imprint template of one embodiment.

### DETAILED DESCRIPTION OF THE INVENTION

In the following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Overview:

It should be noted that the descriptions that follow, for example, in terms of a method for fabricating rectangular BPM is described for illustrative purposes and the underlying system can apply to any number and multiple types of rectangular magnetic bit patterns. In one embodiment of the present invention, the method for fabricating rectangular BPM can be configured using substrate materials including quartz and silicon. The method for fabricating rectangular BPM can be configured to include multiple types of interspersed Phase-Locked-Loop (iPLL) patterns and can be configured to include multiple types of servo patterns using the embodiments.

The interspersed Phase-Locked-Loop (iPLL) pattern fields are integrated into the data fields to produce a signal that is read for the Phase Lock Loop (PLL) control system that generates an output signal whose phase is related to the phase of an input signal. The iPLL magnetic patterned features include a signal that is written to the pattern to create an input signal. The input signal is used to check the down-track timing for reading and writing to the data field features including bits. It accurately positions the head in the alignment of the bits. The servo has a single tone signal that is read for the PLL to check gray code and other servo alignment information.

The physical pattern is not the PLL but provides a group of separate input signals that the PLL analyzes. The PLL control system selects the input signal that is in synchronization with the bit signals and selects that iPLL pattern signal pattern position to access the bits in the down-track alignment.

The iPLL pattern features function to provide a series of timing marks. Since the iPLL patterns are created at the same time as the data features using the same patterning process they are in exact alignment with the rectangular bits. Other methods of creating a separate index and timing mark in a separate process do not enjoy the accuracy due to misalignments caused by multiple installs of a disk to create those non-integrated separate index and timing marks.

In the diagrams shown in the drawings, the lines are depicted as rectangular, but in practice the horizontal lines defining the tracks would be circular rings or spirals concentric with the disk center, while the vertical lines could be either radial segments or arcs to match the path of the read and write elements of the head on the rotating actuator that extend across the entire width of the recording band or for subsections of the band forming different data zones.

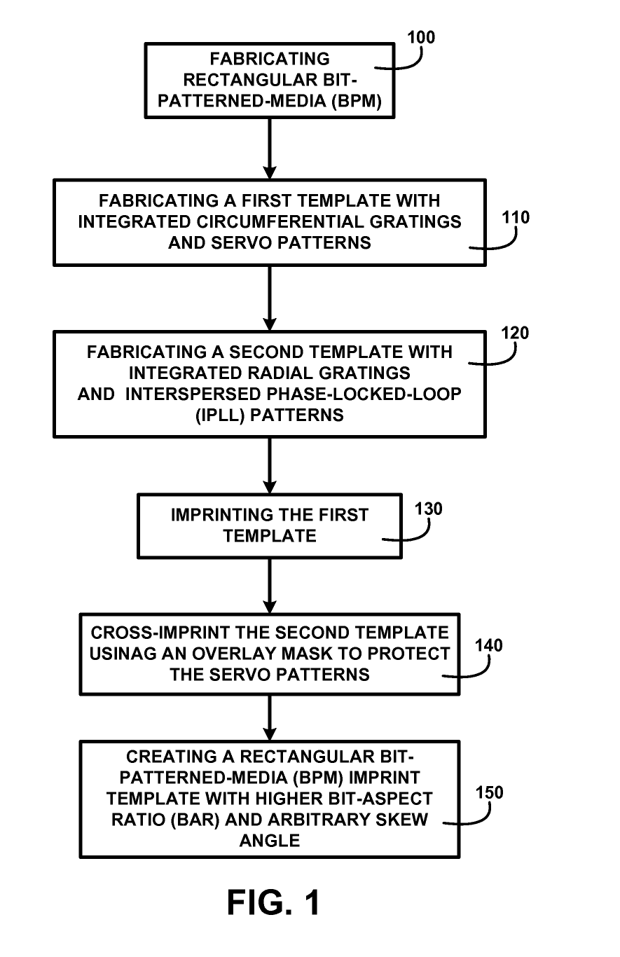

FIG. 1 shows a block diagram of an overview of a method for fabricating rectangular BPM of one embodiment. FIG. 1 shows the processes employed for fabricating rectangular bit-patterned-media (BPM) 100. Rectangular bit-patterned-media includes rectangular patterns including rectangular data islands, rectangular bits and other rectangular features. Rectangular bit-patterned-media (BPM) has features over hexagonally arranged BPM using directed self-assembly (DSA) of block co-polymer (BCP), because it allows for higher bit-aspect ratio (BAR) and arbitrary skew angle. Rectangular BPM can be realized by cross-imprinting one template consisting of circumferential gratings and another template consisting of radial gratings.

The method for fabricating rectangular bit-patterned-media (BPM) 100 includes fabricating a first template with integrated circumferential gratings and servo patterns 110. The first template aligns both the rectangular bits and servo patterns integrating the cross-tract and down-track positioning. The method for fabricating rectangular bit-patterned-media (BPM) 100 includes fabricating a second template with integrated radial gratings and interspersed phase-locked-loop (iPLL) patterns 120. The second template aligns both the rectangular bits and iPLL patterns integrating the cross-tract and down-track positioning of one embodiment.

The processes include imprinting the first template patterns into a third template substrate 130. The imprinting of the first template patterns is followed by cross-imprinting the second template patterns into the third template substrate using an overlay mask to protect the imprinted servo patterns 140. Both imprint operations conclude with etching the first and second template patterns into the third template substrate to create a rectangular bit-patterned-media (BPM) imprint template with higher bit-aspect ratio (BAR) and arbitrary skew angle 150. The rectangular bit-patterned-media (BPM) imprint template is used to imprint BPM stacks of one embodiment.

### DETAILED DESCRIPTION

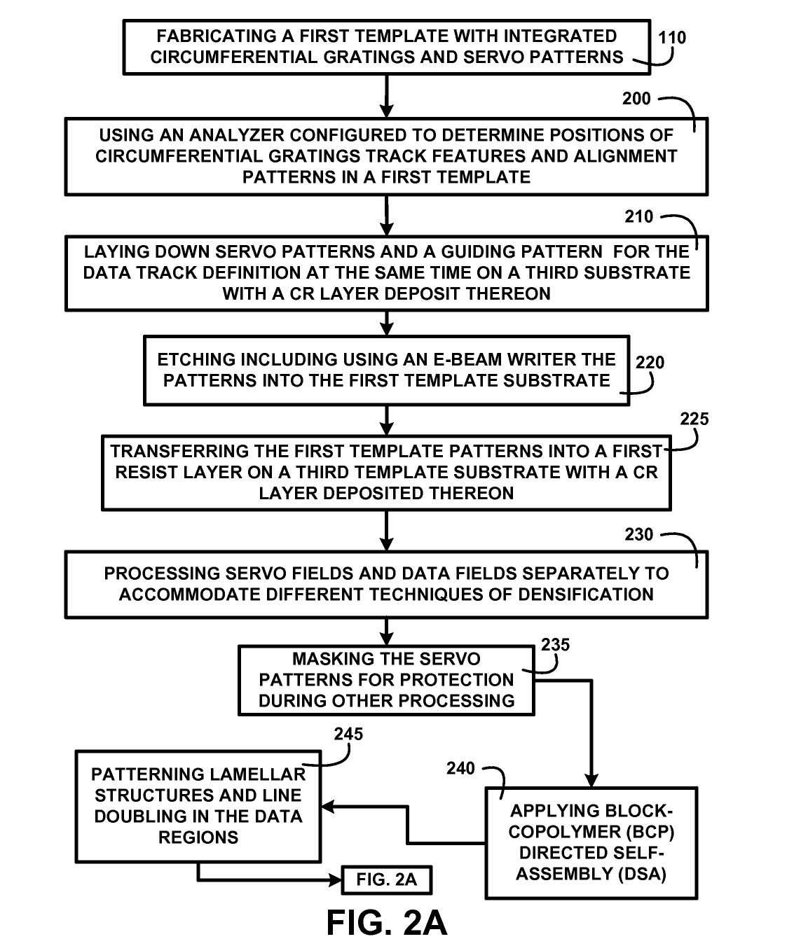

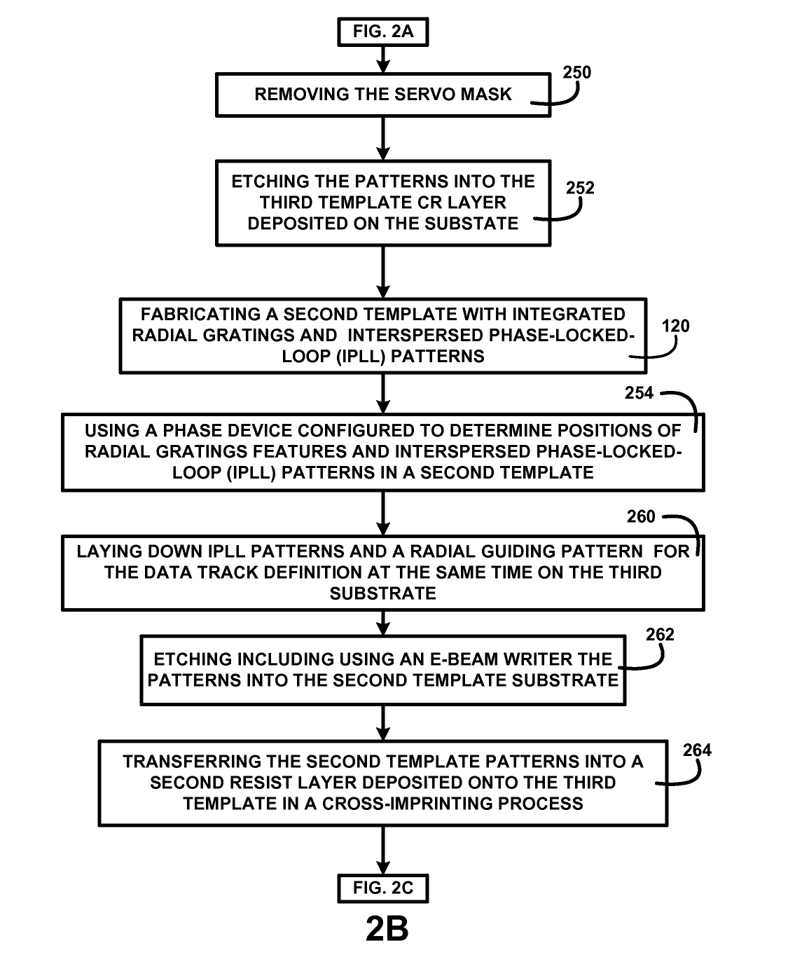

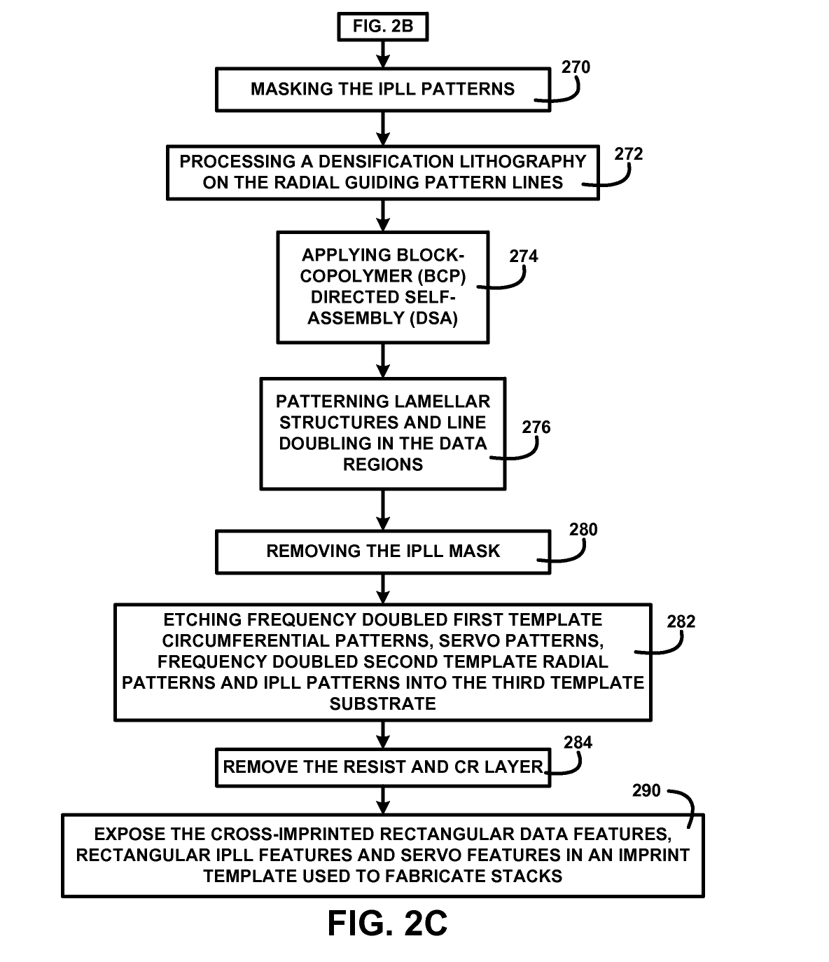

FIG. 2A shows a block diagram of an overview flow chart of a method for fabricating a first template of one embodiment. FIG. 2A shows a process for fabricating a first template with integrated circumferential gratings and servo patterns 110. Fabricating a first template with integrated circumferential gratings and servo patterns 110. Using an analyzer configured to determine positions of circumferential gratings track features and alignment patterns in a first template 200. Laying down servo patterns and a guiding pattern for the data track definition at the same time on a third substrate with a Cr layer deposit thereon 210.

The chromium (Cr) layer is configured to include a deposition of Cr with a thickness including a thickness of ˜5 nm. Etching including using an e-beam writer the patterns into the first template substrate 220. Transferring the first template patterns into a first resist layer on a third template substrate with a Cr layer deposited thereon 225. Processing servo fields and data fields separately to accommodate different techniques of densification 230. Masking the servo patterns for protection during other processing 235. Applying block-copolymer (BCP) directed self-assembly (DSA) 240. Patterning lamellar structures and line doubling in the data regions 245.

The integration process is used for determining the radial position of the circumferential tracks and determining the position of the servo pattern which will be used to radially locate and follow the tracks once the disk is in the drive. The integration processes includes customizing the TPI profile for the surface. Customizing the TPI profile for the surface is used for accommodating heads with different ranges of TPI capability (reader and/or writer widths). The uses of the first and second templates is for dividing the template content makes the selection of TPI and BPI independent of each other.

The processes for fabrication of the first template include laying down servo patterns and a guiding pattern for the data track definition at the same time on a first substrate. The first substrate is configured to include using materials including quartz, silicon (Si) and other materials. The pattern laying down processes include etching including using an e-beam writer. Processing servo fields and data fields separately to accommodate different techniques of densification in the two regions customizes the patterns for differing BPM stack products.

Once the servo patterns and a guiding pattern have been laid down the process continues by a lithographic process including block-copolymer (BCP) directed self-assembly (DSA), multiple patterning and other processes. The lithographic process includes for example applying block-copolymer (BCP) directed self-assembly (DSA). The BCP DSA is used for patterning lamellar structures and line doubling in the data regions. Patterning servo patterns includes e-beam direct write and a lithographic process including block-copolymer (BCP) directed self-assembly (DSA), multiple patterning and other processes. The lithographic process includes for example block-copolymer (BCP) directed self-assembly (DSA) to form spherical structures in the servo fields. The completed BCP DSA lithography is followed by transferring first template patterns into a chromium (Cr) layer on the third substrate. Configuring the first template for the final BPM stack product may include performing tone reversal before pattern transfer of one embodiment.

In another embodiment the first template, the template containing the servo fields, is produced in a two stage process where the complex patterns associated with the servo information are laid down, for example by an e-Beam writer, at the same time as a guiding pattern is laid down for the data track definition. The servo fields and data fields could subsequently be processed separately to accommodate different techniques of densification in the two regions, for example DSA of lamellar structures and line doubling in the data regions and DSA of spherical structures in the servo fields of one embodiment. The continuing processes are described in FIG. 2B.

FIG. 2B shows a block diagram of an overview flow chart of a method for fabricating a second template of one embodiment. FIG. 2B shows the processing continuing from FIG. 2A. The process proceeds by removing the servo mask 250. Etching the patterns into the third template Cr layer deposited on the substrate 252. Fabricating a second template with integrated radial gratings and interspersed phase-locked-loop (iPLL) patterns 120. Using a phase device configured to determine positions of radial gratings features and interspersed phase-locked-loop (iPLL) patterns in a second template 254. Laying down iPLL patterns and a radial guiding pattern for the data track definition at the same time on the third substrate 260. Etching including using an e-beam writer the patterns into the second template substrate 262. Transferring the second template patterns into a second resist layer deposited onto the third template in a cross-imprinting process 264.

The integration process for the second template fabrication includes customizing data rates and zoning for different purposes. The different purposes include producing a disk with a different data capacity per surface and accommodating heads with different ranges of linear density capability. Etched low density lamellar structures guiding patterns are used for creating radial gratings.

The fabrication includes fabricating each grating including the integrated radial gratings including etching e-beam guide patterns including e-beam direct write operations. The guide patterns are used in a lithographic process including block-copolymer (BCP) directed self-assembly (DSA), multiple patterning and other processes. The lithographic process includes for example applying block-copolymer (BCP) directed self-assembly (DSA). The lithographic process is used including applying lamellar directed self-assembly (DSA) to double patterning. Fabricating iPLL patterns includes using e-beam patterning including e-beam direct write and multiplicative patterning including DSA.

Configuring the first template and second template for the final BPM stack product may include performing tone reversal before pattern transfer of one embodiment. The continuing processes are described in FIG. 2C

FIG. 2C shows a block diagram of an overview flow chart of a method for fabricating a third template of one embodiment. FIG. 2C shows a continuation from FIG. 2B with a process for masking the iPLL patterns 270. Continuing is processing densification lithography on the radial guiding pattern lines 272. Applying block-copolymer (BCP) directed self-assembly (DSA) 274. Patterning lamellar structures and line doubling in the data regions 276. Removing the iPLL mask 280 and etching the frequency doubled first template circumferential patterns, servo patterns; frequency doubled second template radial patterns and iPLL patterns into the third template substrate 282. The pattern transfer process is followed by stripping the photoresist and imprint resist materials. Continuing to remove the resist and Cr layer 284 to expose the cross-imprinted rectangular data features, rectangular iPLL features and servo features in an imprint template used to fabricate stacks 290.

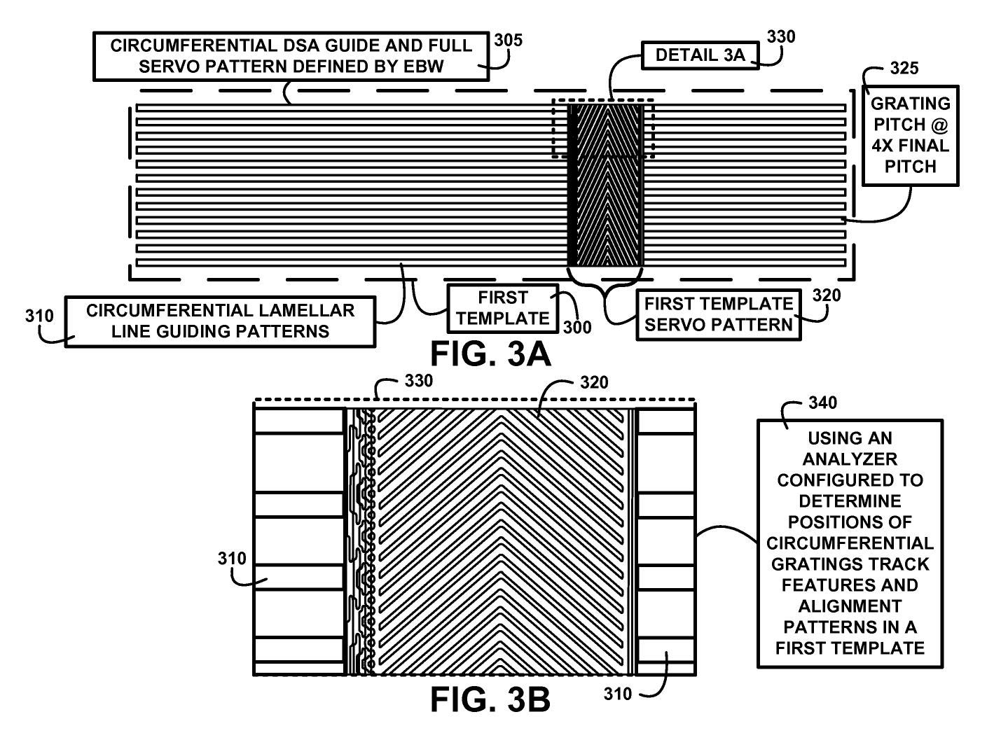

FIG. 3A shows for illustrative purposes only an example of a first template of one embodiment. FIG. 3A shows a first template 300. The first template 300 includes first template servo pattern 320 and circumferential lamellar line guiding patterns 310. The first template is etched into a substrate using e-beam write (EBW). The circumferential lamellar line guiding patterns 310 are used in directed self-assembly (DSA) processes. A lithographic BCP DSA lamellar line doubling process following the low density lamellar structures guiding patterns is used to create additional integrated circumferential gratings. The circumferential DSA guide and full servo pattern defined by EBW 305. A grating pitch@4× final pitch 325 is used for the density of the circumferential lamellar line guiding patterns 310. The patterns are illustrated clearly in detail 3A 330 in FIG. 3B.

FIG. 3B shows for illustrative purposes only an example of determining first template patterns of one embodiment. FIG. 3B shows detail 3A 330 including the first template servo pattern 320 and circumferential lamellar line guiding patterns 310. The process is using an analyzer configured to determine positions of circumferential gratings track features and alignment patterns in a first template 340 of one embodiment.

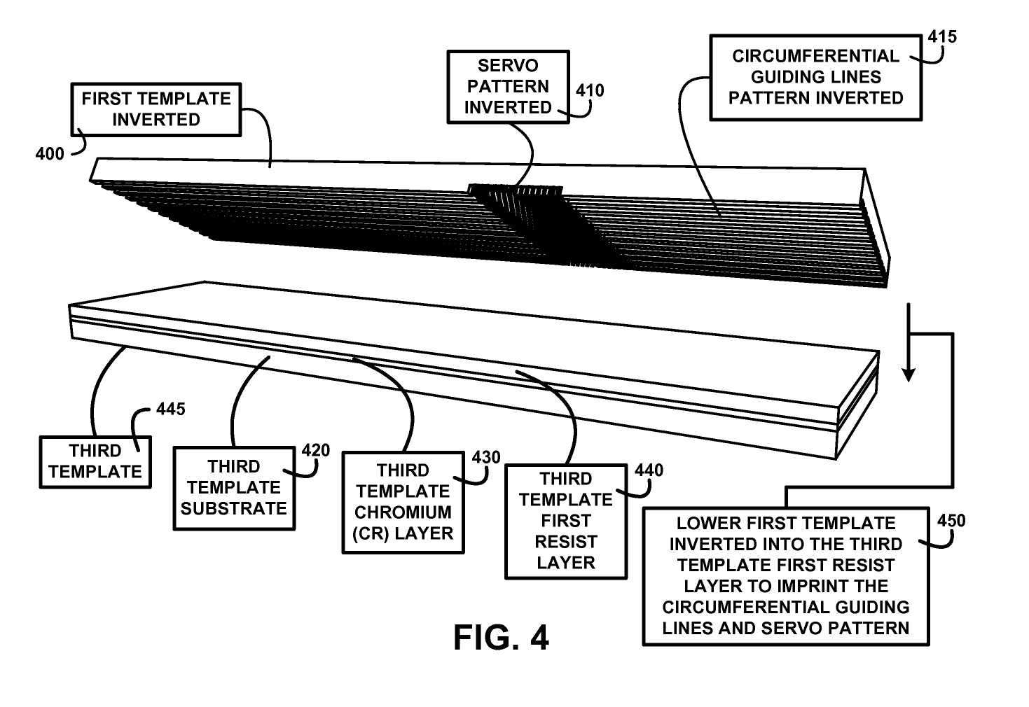

FIG. 4 shows for illustrative purposes only an example of imprinting a third template with first template patterns of one embodiment. FIG. 4 shows the first template inverted 400, servo pattern inverted 410 and circumferential guiding lines pattern inverted 415 as part of an imprinting process. The imprinting process includes a process to lower first template inverted into the third template first resist layer to imprint the circumferential guiding lines and servo pattern 450.

The imprinting is made on a third template substrate 420 that includes a third template chromium (Cr) layer 430 and a third template first resist layer 440. The template substrates are configured to include using materials including quartz, silicon (Si) and other materials. The third template chromium (Cr) layer is configured to include a deposition of Cr with a thickness including a thickness of ˜5 nm. The imprinted third template 445 is processed using lithography of one embodiment.

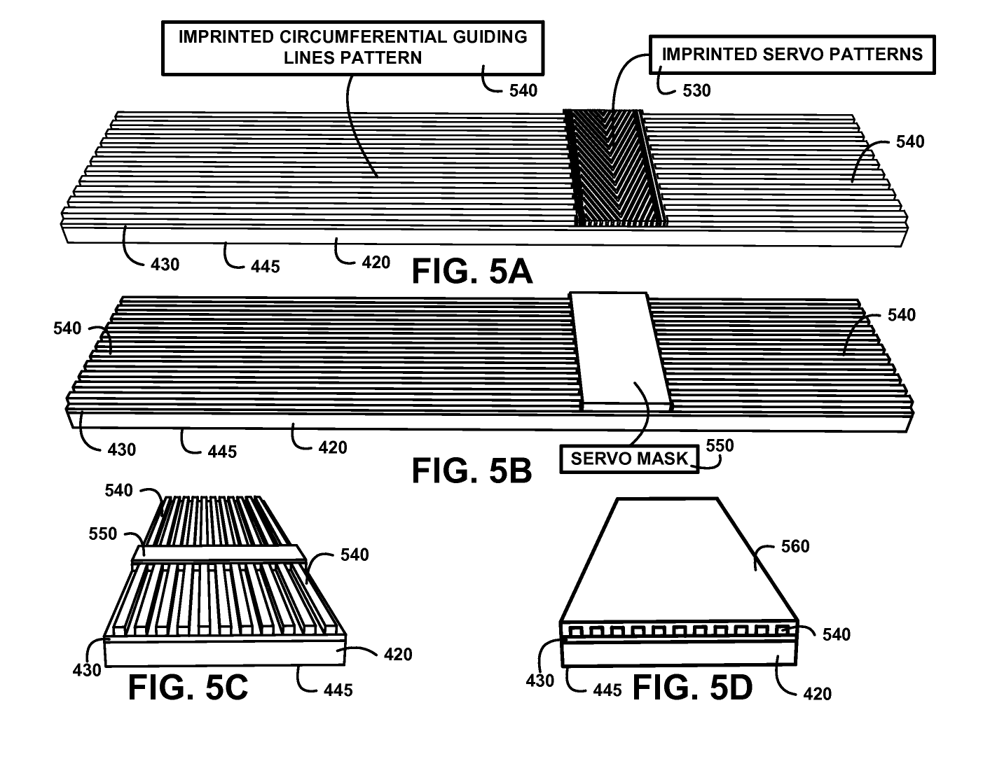

FIG. 5A shows for illustrative purposes only an example of a third template with first template imprinted patterns of one embodiment. FIG. 5A shows the third template 445, third template substrate 420, third template chromium (Cr) layer 430 and imprinted servo patterns 530 and imprinted circumferential guiding lines pattern 540. FIG. 5B shows for illustrative purposes only an example of a servo mask of one embodiment. FIG. 5B shows the third template 445, third template substrate 420 and third template chromium (Cr) layer 430. The third template 445 includes imprinted circumferential guiding lines pattern 540. A servo mask 550 is deposited on the servo patterns to prevent damage during other processing. An overlay mask protection process includes lithography processing an overlay mask on the third substrate to protect the servo patterns. No patterns are transferred into the protected servo region. The overlay mask protection process includes spin coating a photoresist layer on the imprinted Cr layer on the third substrate of one embodiment. An apparatus is used for aligning, exposing, and developing the photoresist covering the servo regions. The resist layer is exposed to for example a photo curing process including ultraviolet light. The portion of the the photoresist covering the servo regions is cured. Once cured the balance of the photoresist not covering the servo regions is removed. The remaining cured portion of the photoresist forms an overlay mask configured to protect the integrated servo pattern region of the patterned third Cr layer in subsequent processing of one embodiment.

FIG. 5C shows for illustrative purposes only an example of circumferential grating guiding pattern density of one embodiment. FIG. 5C shows the third template 445, third template substrate 420 and third template chromium (Cr) layer 430. The imprinted circumferential guiding lines pattern 540 and servo mask 550 are shown from an end prospective to illustrate the pitch of the imprinted circumferential guiding lines pattern 540.

FIG. 5D shows for illustrative purposes only an example of a third template with a second resist deposition of one embodiment. FIG. 5D shows the third template 445, third template substrate 420 and third template chromium (Cr) layer 430. A third template second resist layer 560 is shown deposited on the imprinted features.

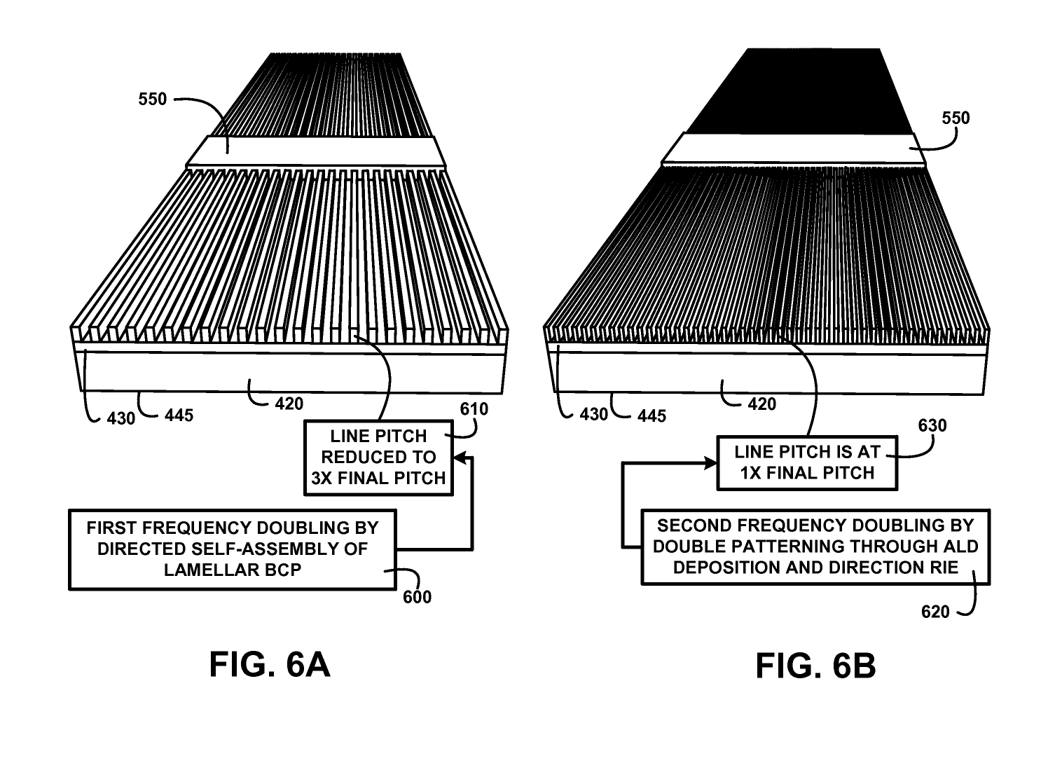

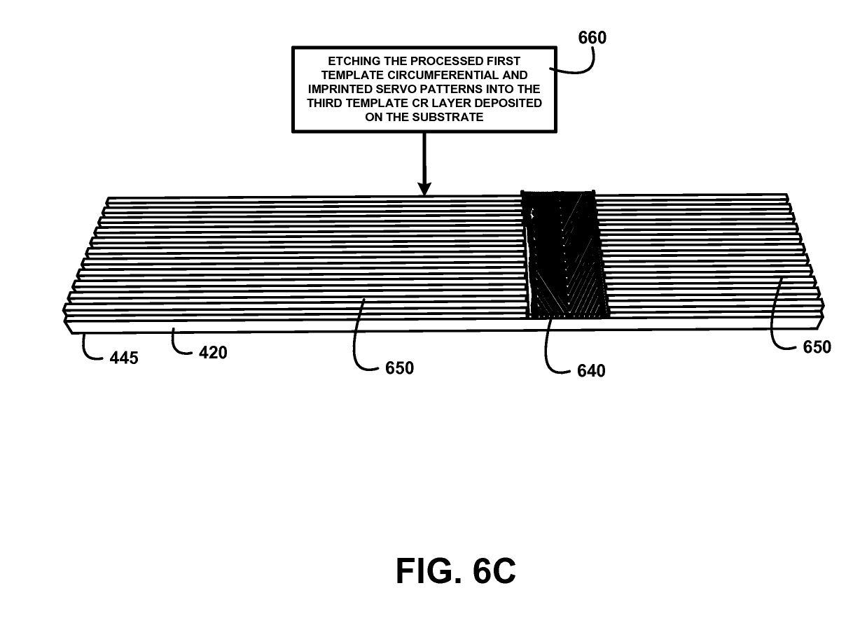

FIG. 6A shows for illustrative purposes only an example of first frequency doubling of circumferential guiding patterns of one embodiment. FIG. 6A shows the third template 445, third template substrate 420 and third template chromium (Cr) layer 430. The servo mask 550 is seen protecting the servo patterns during a first frequency doubling by directed self-assembly of lamellar BCP 600. The first frequency doubling by directed self-assembly of lamellar BCP 600 is used to alter a line pitch reduced to 3× final pitch 610 based on the imprinted grating pitch@4× final pitch 325 of the circumferential guiding lines.

FIG. 6B shows for illustrative purposes only an example of second frequency doubling of circumferential guiding patterns of one embodiment. FIG. 6B shows he third template 445, third template substrate 420 and third template chromium (Cr) layer 430. The servo mask 550 is in view. A second frequency doubling by double patterning through ALD deposition and direction RIE 620 has altered the line pitch reduced to 3× final pitch 610 of FIG. 6A to a line pitch at lx final pitch 630.

FIG. 6C shows for illustrative purposes only an example of first template patterns etched into a third template perspective view of a first template of one embodiment. FIG. 6C shows the third template 445, third template substrate 420 and servo patterns etched into third template Cr layer 640. In addition processed circumferential lines etched into the third template substrate 650 are shown at a line pitch that does not illustrate that the line pitch is at lx final pitch 630. This is to provide clear visualization of FIG. 6C which at the illustrated pitch of FIG. 6B would appear as a solid mass with little detail.

The imprint is used for patterning a resist layer deposited on a third substrate with a Cr layer thereon. Once the patterned resist layer is cured a process is used for transferring the first template patterns into a chromium (Cr) layer on the third substrate followed by removing the imprinted resist materials. An etch process is used for etching the processed first template circumferential and imprinted servo patterns into the third template Cr layer deposited on the substrate 660 of one embodiment.

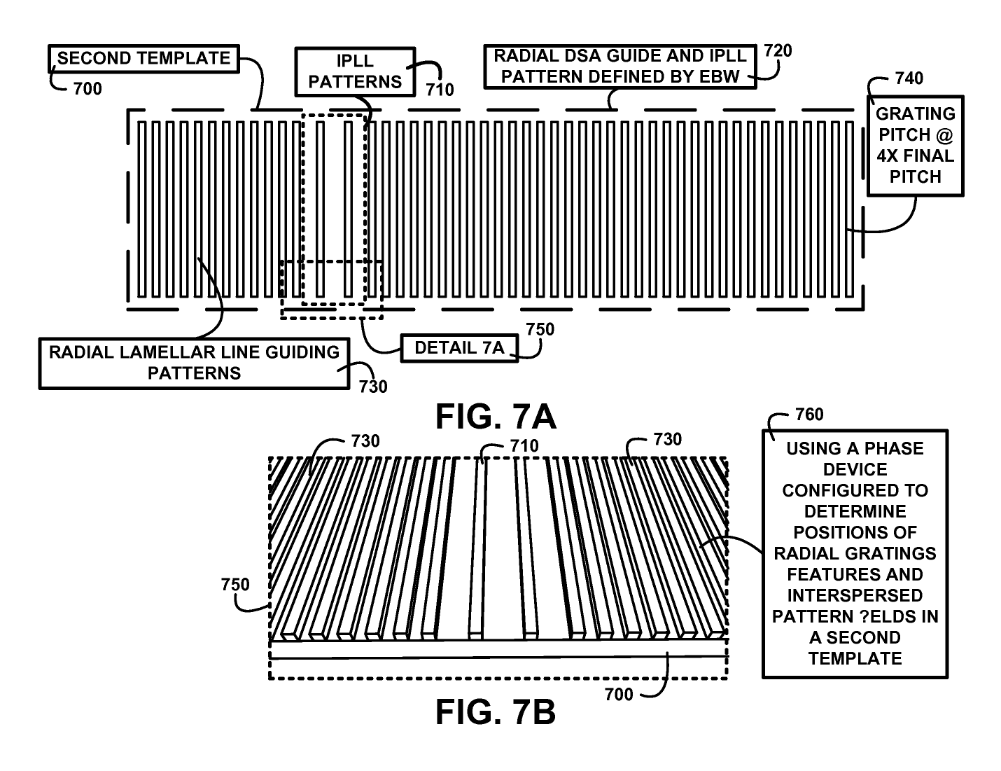

FIG. 7A shows for illustrative purposes only an example of a second template of one embodiment. FIG. 7A shows a second template 700. The second template 700 includes iPLL patterns 710 and radial lamellar line guiding patterns 730. The radial DSA guide and iPLL pattern defined by EBW 720 include a grating pitch@4× final pitch 740. Details of the features in the patterns are shown in detail 7A 750.

FIG. 7B shows for illustrative purposes only an example of determining a second template patterns of one embodiment. FIG. 7B shows detail 7A 750. The second template 700, iPLL patterns 710 and radial lamellar line guiding patterns 730 can be clearly seen. The fabrication processing of the second template 700 is using a phase device configured to determine positions of radial gratings features and interspersed pattern fields in a second template 760 of one embodiment.

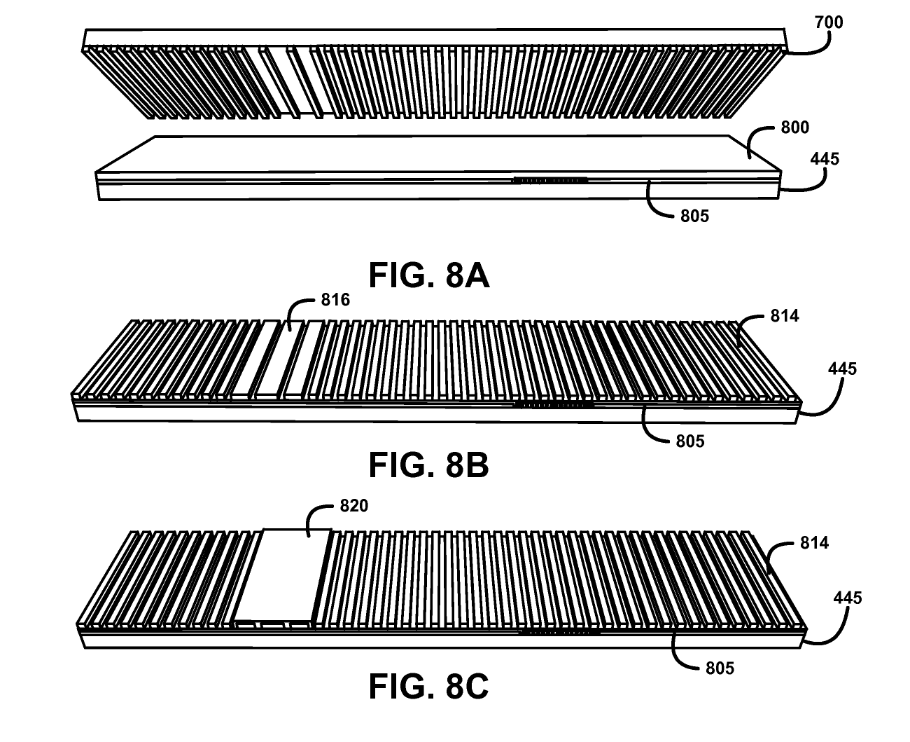

FIG. 8A shows for illustrative purposes only an example of a third template resist imprinted with second template patterns of one embodiment. FIG. 8A shows the third template 445 including a third template third resist layer 800 deposited on the etched features of the first template patterns etched Cr layer 805. The second template 700 is inverted to imprint the third template third resist layer 800. An imprint process is configured for cross-imprinting the second resist layer on the third substrate using the second template.

An apparatus and process are configured to be used for integrating the template features alignment of both templates. The apparatus and process are used for determining the radial position of the tracks (first template) also determines the servo pattern which will be used to radially locate and follow the tracks once the disk is in the drive. The apparatus and process are used for determining the down-track position of the second template which also determines the location of the iPLL fields which will be used in the drive to set the timing to synchronize writes and/or reads to the rectangular features including data islands and bits.

The imprint process is configured for aligning the second template wherein the imprint angular alignment is less than 1 degree putting the iPLL in phase with the rectangular data patterns. The cross-imprinted resist is cured and a process is used for transferring the second template patterns into the third Cr layer on the third substrate followed by removing the cross-imprinted resist materials.

FIG. 8B shows for illustrative purposes only an example of first template patterns etched into a third Cr layer of one embodiment. FIG. 8B shows the third template 445 and etched Cr layer 805. Also shown are imprinted radial guiding lines pattern 814 and imprinted iPLL patterns 816. A BCP DSA lamellar line doubling process is used to create additional integrated radial gratings.

FIG. 8C shows for illustrative purposes only an example of an iPLL mask of one embodiment. FIG. 8C shows the third template 445 and etched Cr layer 805. An iPLL patterns mask 820 is shown deposited on top of the iPLL patterns imprint. The iPLL patterns mask 820 prevent damage during other processing. The imprinted radial guiding lines pattern 814 are shown unprotected in preparation for additional processing. The overlay mask is created by curing a section of the photoresist layer covering the iPLL patterns mask 820. Subsequently a process is used for removing the non-exposed and developed photoresist materials not covering the iPLL patterns mask 820.

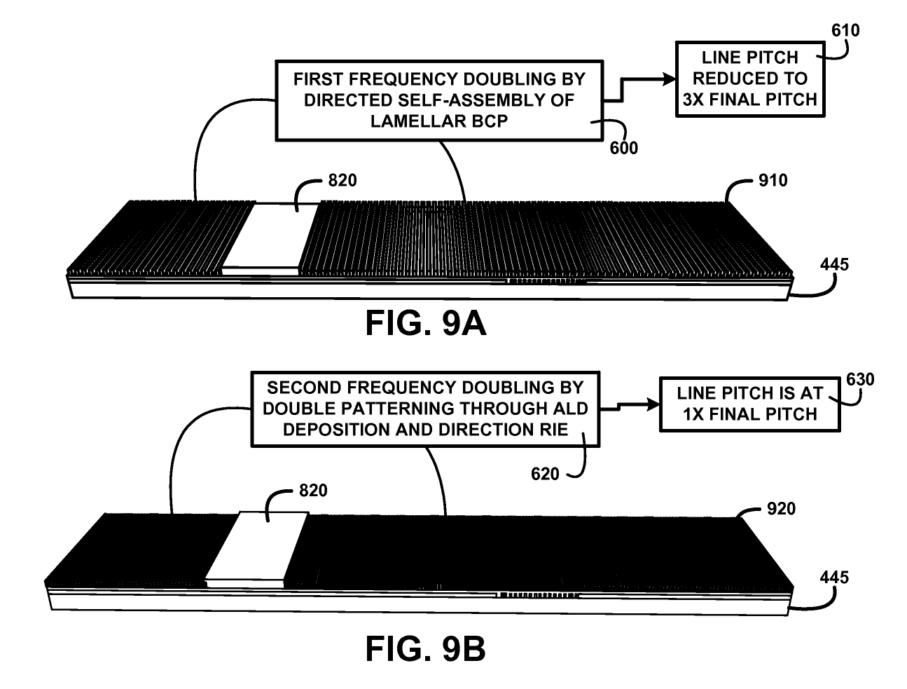

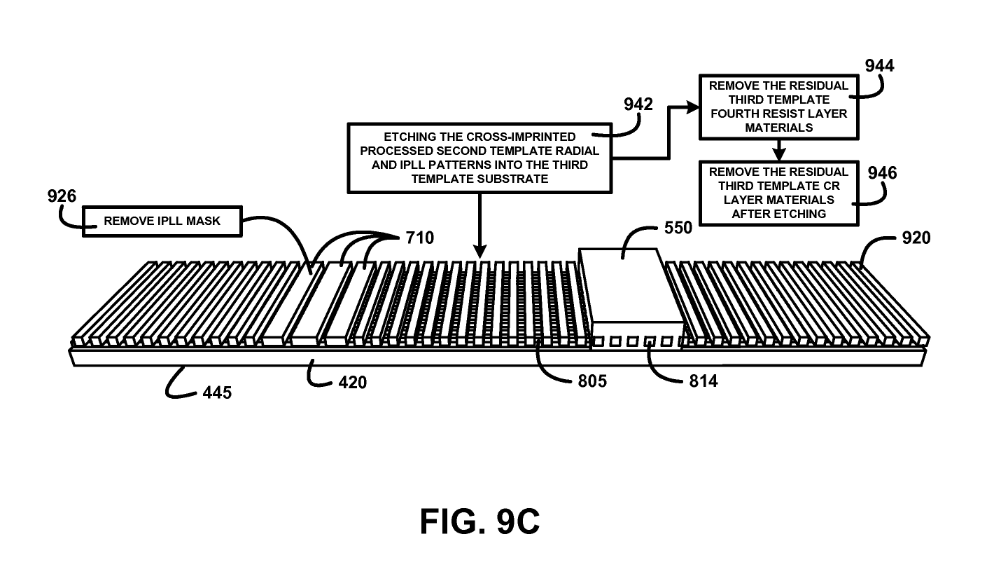

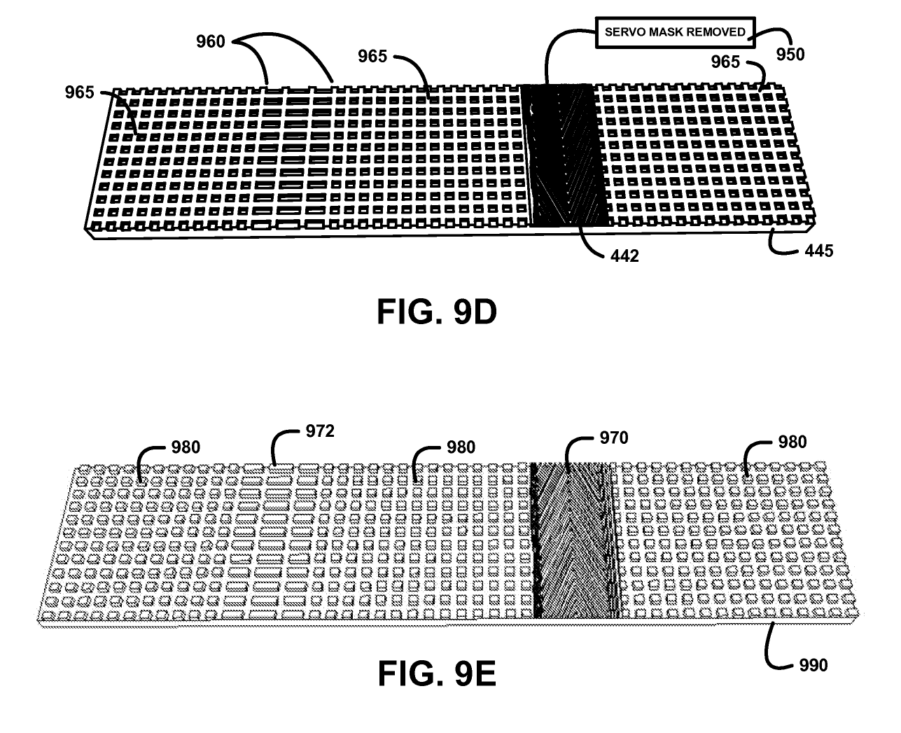

FIG. 9A shows for illustrative purposes only an example of first frequency doubling of radial guiding patterns of one embodiment. FIG. 9A shows the third template 445 and iPLL patterns mask 820. A first frequency doubling by directed self-assembly of lamellar BCP 600 is used to alter the grating pitch@4× final pitch 740 of FIG. 7A. The first frequency doubling by directed self-assembly of lamellar BCP 600 produces a line pitch reduced to 3× final pitch 610 as seen in first frequency double density radial lines 910.

FIG. 9B shows for illustrative purposes only an example of second frequency doubling of radial guiding patterns of one embodiment. FIG. 9B shows the third template 445 and iPLL patterns mask 820. Multiplicative frequency doubling includes processes including atomic layer deposition (ALD) and reactive-ion etching (RIE). A second frequency doubling by double patterning through ALD deposition and direction RIE 620. The second frequency doubling will alter the density of the radial lines to a line pitch is at 1× final pitch 630 producing second frequency double density radial lines 920 of one embodiment.

FIG. 9C shows for illustrative purposes only an example of second template patterns etched in the third template of one embodiment. FIG. 9C shows the third template 445, third template substrate 420 and servo mask 550. The processed circumferential lines etched into third template substrate 650 are shown in the etched Cr layer 805. Residual imprinted radial guiding pattern lines 814 can be seen in the resist covering the servo mask 550 of FIG. 5B. An etch process is used for etching the cross-imprinted processed second template radial and iPLL patterns into the third template substrate 942. The etch process excludes a non-patterned integrated servo region.

After the etching process another process is used to remove the residual third template fourth resist layer materials 944 and to remove the residual third template Cr layer materials after etching 946. The iPLL patterns 710 can be seen clearly with the iPII mask removed. In addition second frequency double density radial lines 920 are shown at a line pitch that does not illustrate that the line pitch is at 1× final pitch 630. This is to provide clear visualization of FIG. 9C which at the illustrated pitch of FIG. 9B would appear as a solid mass with little detail.

FIG. 9D shows for illustrative purposes only an example of a cross-imprinted rectangular patterned imprint template of one embodiment. FIG. 9D shows the third template 445 with the servo mask removed 950. This now shows the etched patterned servo patterns 442 and rectangular etched iPLL patterns 960 and rectangular etched bits 965 forming an imprint template to be used in fabrication patterned media stacks. The integration of the patterns in the two cross-imprinting templates, the first template and second template, create accurate alignments of the various patterns to one another. The integrated alignment prevents misreading and miswriting of data.

FIG. 9E shows for illustrative purposes only an example of a stack imprinted using the cross-imprinted rectangular patterned imprint template of one embodiment. FIG. 9E shows stack media imprinted with integrated servo patterns 970 and stack media imprinted with integrated iPLL patterns 972. A stack media imprinted with rectangular data bits 980 provides an imprinted stack with integrated servo, iPLL and data features 990 to provide accuracy in the functions the stack media. The first template and second template patterns transferred into the third substrate is used for creating a rectangular bit-patterned-media (BPM) imprint template with higher bit-aspect ratio (BAR) and arbitrary skew angle.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

1.-20. (canceled)

21. An apparatus, comprising:
a first set of rectangular features etched into a substrate;
a second set of rectangular features etched into the substrate,
wherein the first and second sets of rectangular features are aligned along a circumference of the substrate, and
wherein the first and second sets of rectangular features have different pitches from each other along the circumference; and
a set of chevrons etched into the substrate.

22. The apparatus of claim 21,
wherein the apparatus is a template for fabrication of bit-patterned media.

23. The apparatus of claim 21,
wherein the substrate is quartz or silicon.

24. The apparatus of claim 21,
wherein the first set of rectangular features has a greater aspect ratio than the second set of rectangular features.

25. The apparatus of claim 21,
wherein the first set of rectangular features corresponds to one or more interspersed phase-locked loop fields for bit-patterned media, and
wherein the set of chevrons corresponds to one or more servo patterns for bit-patterned media.

26. The apparatus of claim 25,
wherein the second set of rectangular features corresponds to one or more data fields for bit-patterned media.

27. An apparatus, comprising:
a first set of rectangular features etched into a substrate;
a second set of rectangular features etched into the substrate,
wherein the first set of rectangular features has a greater aspect ratio than the second set of rectangular features; and
a set of chevrons etched into the substrate.

28. The apparatus of claim 27,
wherein the first and second sets of rectangular features are aligned along a circumference of the substrate.

29. The apparatus of claim 27,
wherein the first set of rectangular features is aligned along a first radius of the substrate, and
wherein the second set of rectangular features is aligned along a second radius of the substrate.

30. The apparatus of claim 27,
wherein the first set of rectangular features is aligned along a first arc of the substrate, and
wherein the second set of rectangular features is aligned along a second arc of the substrate.

31. The apparatus of claim 27,
wherein the first set of rectangular features corresponds to one or more interspersed phase-locked loop fields for bit-patterned media, and
wherein the set of chevrons corresponds to one or more servo patterns for bit-patterned media.

32. The apparatus of claim 31,
wherein the second set of rectangular features corresponds to one or more data fields for bit-patterned media.

33. The apparatus of claim 31,
wherein the apparatus comprises a quartz or silicon template for fabrication of bit-patterned media.

34. An apparatus, comprising:
a first set of rectangular features etched into a substrate;
a second set of rectangular features etched into the substrate,
wherein the first and second sets of rectangular features have different aspect ratios from each other; and
a set of chevrons etched into the substrate.

35. The apparatus of claim 34,
wherein a first portion of each of the first and second sets of rectangular features are aligned along a circumference of the substrate.

36. The apparatus of claim 35,
wherein a second portion of the first set of rectangular features is aligned along a first radius of the substrate, and
wherein a second portion of the second set of rectangular features is aligned along a second radius of the substrate.

37. The apparatus of claim 35,
wherein a second portion of the first set of rectangular features is aligned along a first arc of the substrate, and
wherein a second portion of the second set of rectangular features is aligned along a second arc of the substrate.

38. The apparatus of claim 35,
wherein the first set of rectangular features corresponds to one or more interspersed phase-locked loop fields for bit-patterned media,
wherein the second set of rectangular features corresponds to one or more data fields for bit-patterned media, and
wherein the set of chevrons corresponds to one or more servo patterns for bit-patterned media.

39. The apparatus of claim 34,
wherein the apparatus comprises a quartz or silicon template for fabrication of bit-patterned media.

40. The apparatus of claim 39,
wherein the template is characteristic of a cross-imprinting process using a first template comprising circumferential gratings and a second template comprising two different sets of radial gratings, and
wherein the angular alignment of the first and second templates is <1°.
